(19) United States
(12) Patent Application Publication
(10) Pub. No.: US 2019/0063644 A1
(43) Pub. Date: Feb. 28, 2019

(54) LOCK BAND AND METHOD OF MANUFACTURING

(71) Applicant: AIR DISTRIBUTION TECHNOLOGIES IP, LLC, Milwaukee, WI (US)

(72) Inventors: Daniel J. Gramza, Rockford, MI (US); Eric W. Palmbos, Allendale, MI (US); Michael R. Lutz, Allendale, MI (US); Keith E. Page, Zeeland, MI (US); Clark E. Pridemore, Grand Rapids, MI (US)

(21) Appl. No.: 16/116,645

(22) Filed: Aug. 29, 2018

Related U.S. Application Data
(63) Continuation of application No. 14/065,307, filed on Oct. 28, 2013, now abandoned.

(51) Int. Cl. F16L 21/06

(52) U.S. Cl. CPC F16L 21/06

(57) ABSTRACT

A device comprising an adjustable band configured to be installed around a pipe and a locking assembly disposed on the adjustable band.

### TECHNICAL FIELD

The present disclosure relates to pipe fittings, and more specifically to a lock band that can be used to secure two pipes together.

### BACKGROUND OF THE INVENTION

Piping can include male and female fittings, where the male fitting can be inserted into the female fitting in order to form a joint.

### SUMMARY OF THE INVENTION

A device comprising a band configured to be installed around a pipe is disclosed, with a locking assembly disposed on the band that locks to a pipe joint assembly.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a dual lock band in accordance with an exemplary embodiment of the present disclosure;

FIG. 2 is a diagram of a unitary lock band with a hooked attachment in accordance with an exemplary embodiment of the present disclosure;

FIG. 3 is a diagram of a unitary lock band with a lanced clip in accordance with an exemplary embodiment of the present disclosure;

FIG. 4 is a diagram of a dual lock band installed on a pipe fitting in accordance with an exemplary embodiment of the present disclosure;

FIG. 5 is a diagram of a unitary lock band with a hooked attachment installed on a pipe fitting in accordance with an exemplary embodiment of the present disclosure; and

FIG. 6 is a diagram of a unitary lock band with a lanced clip installed on a pipe fitting in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

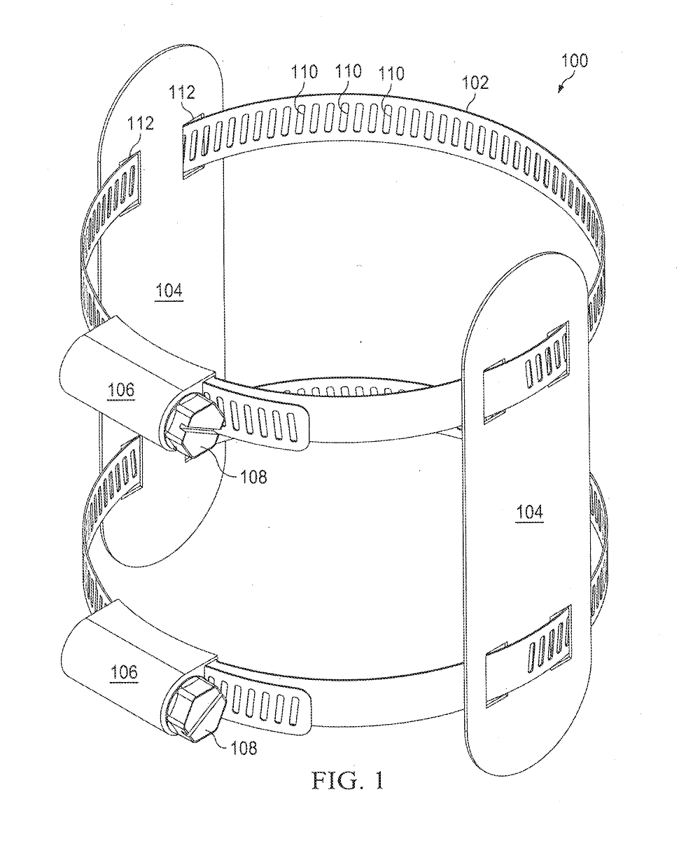

FIG. 1 is a diagram of a dual lock band 100 in accordance with an exemplary embodiment of the present disclosure. Dual lock band 100 can be made from metal, plastic or other suitable materials.

Dual lock band 100 includes adjustable bands 102, which are configured to be placed on adjacent pipe segments that have been mated to form a joint. Adjustable bands 102 are fed through lock band straps 104, which hold the adjustable bands 102 in a predetermined relationship, so as to secure the adjacent pipe segments. In one exemplary embodiment, a pipe segment with a female pipe fitting will include a flare that increases the outer diameter of the pipe end, and the male pipe fitting can be placed inside of the female pipe fitting to form a joint. Dual lock band 100 can be installed on the male and female pipe ends after the joint is formed, and prevents the male and female pipe segments from separation. Although adjustable bands are shown and described both here and throughout the application, a band that is not adjustable can also or alternatively be used, where suitable.

Dual lock band 100 can be manufactured from metal bands, which are machined to form a number of slots 110 along the length of the metal band. A lock assembly 106 can be secured to one end of the metal band, and can include a slot for receiving the other end of the metal band. A locking mechanism (not explicitly shown) within lock assembly 106 is then inserted into one or more of slots 110, and screw 108 the lock mechanism to secure lock assembly 106 to the metal band. Prior to inserting the metal band into lock assembly 106, the metal band is inserted through lock band straps 104. In one exemplary embodiment, a hose clamp assembly can be used for adjustable bands 102. Lock band straps 104 can be made from plastic or metal, although a durable and flexible plastic can be used to improve the ease of assembly without detracting from the reliability of dual lock band 100. Each lock band strap 104 includes four slots 112, with two slots disposed on either end and configured to allow adjustable band 102 to be threaded through each slot as shown, so as to secure lock band strap 104 to each adjustable band 102. Although two slots are shown, a single slot or other suitable numbers of slots can also or alternatively be used.

In operation, dual lock band 100 provides a mechanism for securely and reliably ensuring that two pipes at a pipe joint will remain jointed. Dual lock band 100 can be readily manufactured and assembled on site prior to forming a pipe joint.

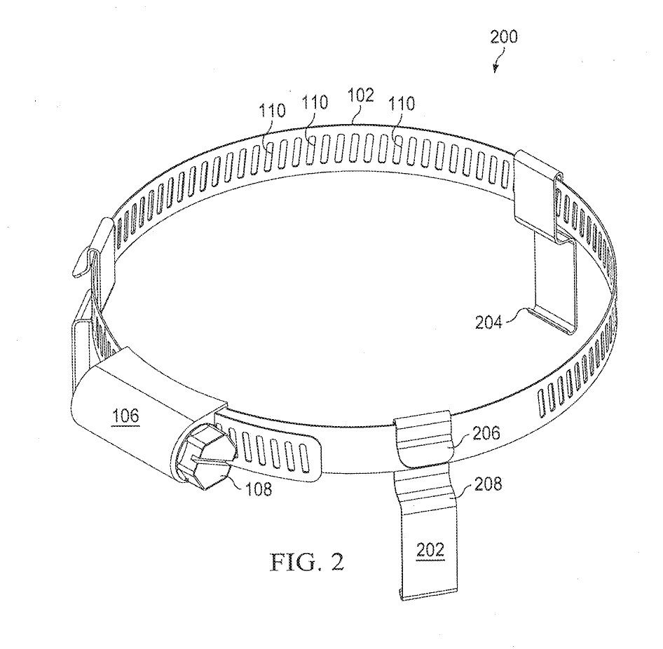

FIG. 2 is a diagram of a unitary lock band 200 with a hooked attachment in accordance with an exemplary embodiment of the present disclosure. Unitary lock band 200 includes three attachments 202, which each include clip 206 that secures attachment 202 to adjustable band 102, and hook 204 that hooks to an edge of the female pipe fitting, such as a gasket bead or other suitable edges. Attachment 202 includes a bend 208 that is provided to allow attachment 200 to clip over the female pipe fitting. In this exemplary embodiment, unitary lock band 200 can be placed on the male pipe fitting before or after the pipe joint is formed. Although unitary lock band 200 is shown with adjustable band 102, lock assembly 106 and screw 108, unitary lock band 200 can alternatively be a solid band that fits over the end of the male pipe fitting prior to forming the joint, such as a metal band, a plastic band, a composite band, a fiberglass band or a band formed of other suitable materials, and attachment 202 can be fitted onto unitary lock band 200 prior to assembly on the pipe fitting. Likewise, unitary lock band 200 can be manufactured in place on a pipe fitting where suitable, or other suitable configurations can also or alternatively be implemented.

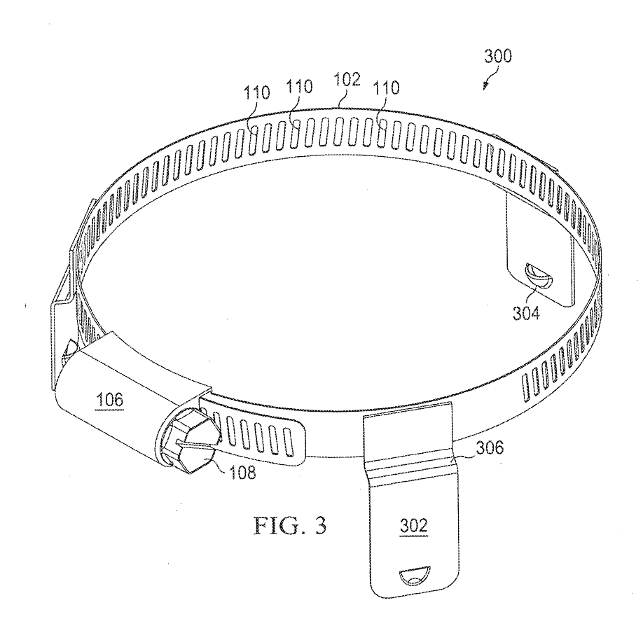

FIG. 3 is a diagram of a unitary lock band 300 with a lanced clip in accordance with an exemplary embodiment of the present disclosure. Unitary lock band 300 includes three attachments 302, which can each be welded or otherwise secured to adjustable band 102. Lance 304 is formed in attachment 302, such as by lancing, punching or my otherwise causing part of attachment 302 to extend outwards from bent portion 306. In this exemplary embodiment, unitary lock band 300 can be placed on the male pipe fitting before or after the pipe joint is formed. Although unitary lock band 300 is shown with adjustable band 102, lock assembly 106 and screw 108, unitary lock band 300 can alternatively be a solid band that fits over the end of the male pipe fitting prior to forming the joint, such as a metal band, a plastic band, a composite band, a fiberglass band or a band formed of other suitable materials, and attachment 302 can be welded onto unitary lock band 300 prior to assembly on the pipe fitting. Likewise, unitary lock band 300 can be manufactured in place on a pipe fitting where suitable, or other suitable configurations can also or alternatively be implemented.

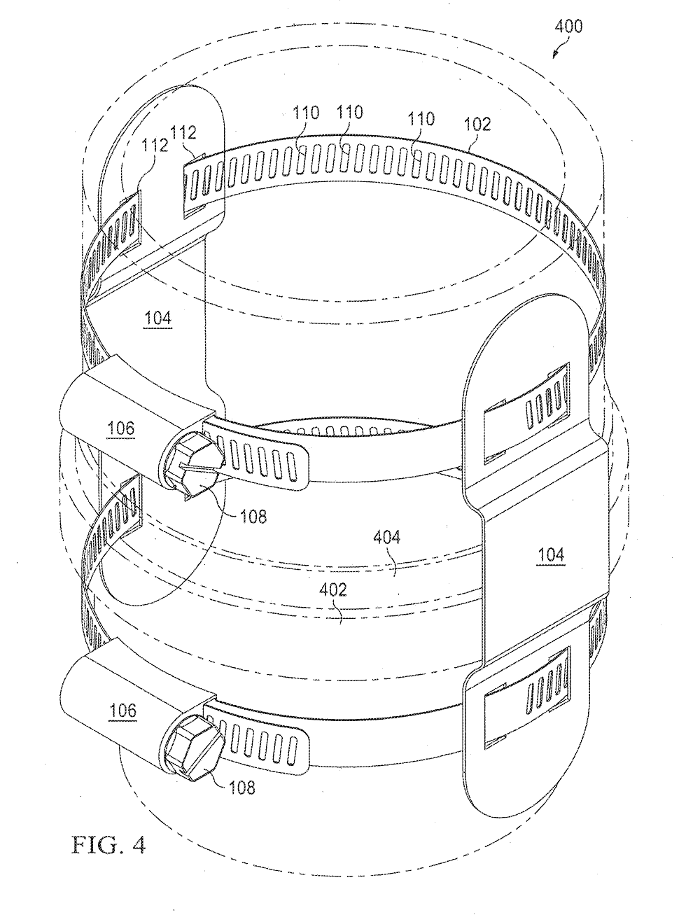

FIG. 4 is a diagram of a dual lock band 100 installed on a pipe fitting 400 in accordance with an exemplary embodiment of the present disclosure. As shown in FIG. 4, adjustable bands 102 of dual lock band 100 are disposed on either side of the joint formed by female pipe fitting 402 and male pipe fitting 404 (shown transparent). In this manner, female pipe fitting 402 and male pipe fitting 404 cannot separate as long as dual lock band 100 remains in place and operational. Adjustable bands 102 can be installed on female pipe fitting 402 and male pipe fitting 404 after the joint is formed.

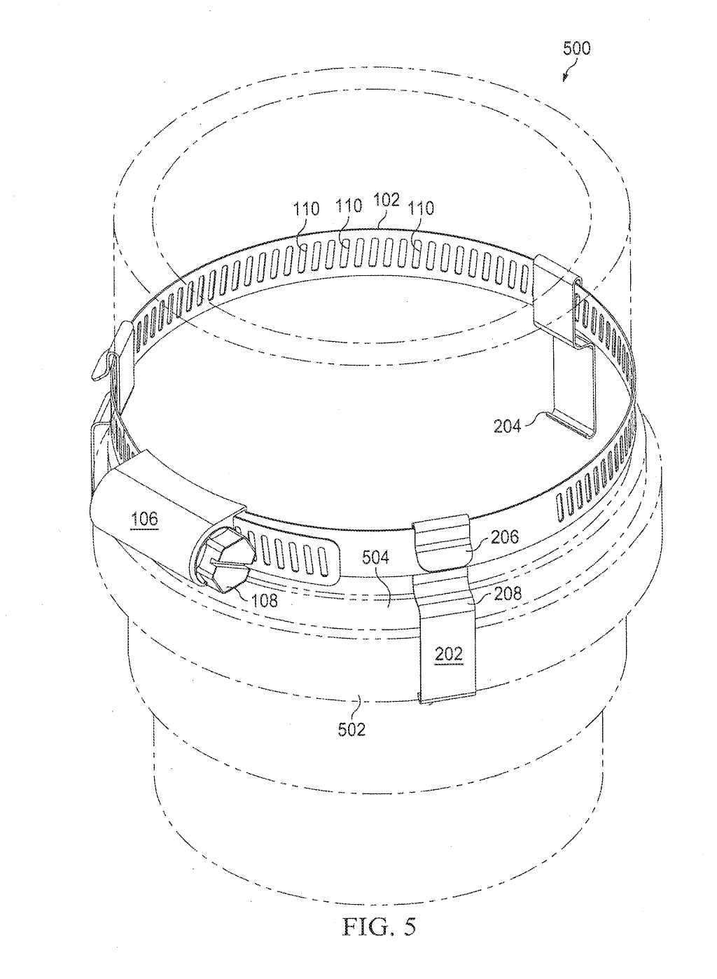

FIG. 5 is a diagram of a unitary lock band 200 with a hooked attachment installed on a pipe fitting 500 in accordance with an exemplary embodiment of the present disclosure. As shown in FIG. 5, adjustable band 102 of unitary lock band 200 is disposed on the male pipe fitting of the joint formed by female pipe fitting 502 and male pipe fitting 504 (shown transparent), and hook 204 is placed over female pipe fitting 502. Bend 206 is used to ensure that attachment 202 can fit over female pipe fitting 502. In this manner, female pipe fitting 502 and male pipe fitting 504 cannot separate as long as unitary lock band 200 remains in place and operational. Adjustable band 102 can be installed on male pipe fitting 504 after the joint is formed. Alternatively, a non-adjustable band can be installed on male pipe fitting 504 before the joint is formed, and attachment 202 can be clipped on the non-adjustable band before or after the joint is formed.

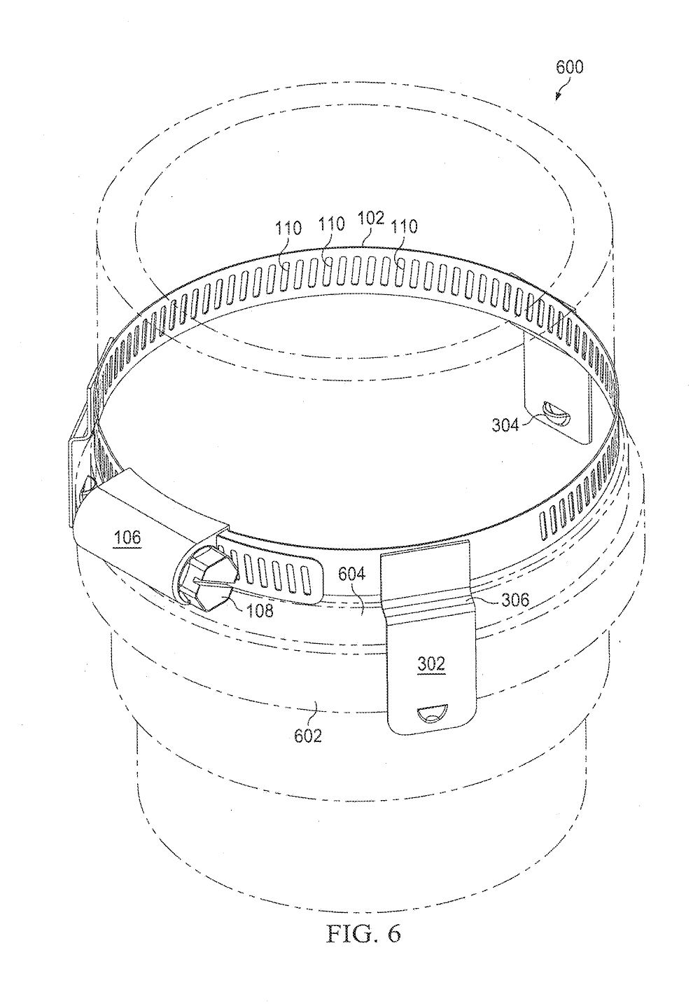

FIG. 6 is a diagram of a unitary lock band 300 with a lanced clip installed on a pipe fitting 600 in accordance with an exemplary embodiment of the present disclosure. As shown in FIG. 5, adjustable band 102 of unitary lock band 300 is disposed on the male pipe fitting of the joint formed by female pipe fitting 602 and male pipe fitting 604 (shown transparent), and protrusion 304 is placed over female pipe fitting 602. Bend 306 is used to ensure that attachment 302 can fit over female pipe fitting 602. In this manner, female pipe fitting 602 and male pipe fitting 604 cannot separate as long as unitary lock band 300 remains in place and operational. Adjustable band 102 can be installed on male pipe fitting 604 after the joint is formed. Alternatively, a non-adjustable band can be installed on male pipe fitting 604 before the joint is formed, and attachment 302 can be welded on the non-adjustable band before or after the joint is formed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1-20. (canceled)

21. A pipe fitting system, comprising:
a first adjustable band configured to be secured to a first pipe segment;
a second adjustable band configured to be secured to a second pipe segment, wherein the first pipe segment is axially aligned with the second pipe segment; and
a lock band strap having a plurality of holes, wherein the first adjustable band is configured to be fed through a first hole and a second hole of the plurality of holes and the second adjustable band is configured to be fed through a third hole and a fourth hole of the plurality of holes, and wherein the lock band strap is configured to maintain a connection between the first pipe segment and the second pipe segment.

22. The pipe fitting system of claim 21, wherein the first adjustable band includes a lock assembly configured to adjust a diameter of the first adjustable band.

23. The pipe fitting system of claim 22, wherein the lock assembly includes a fastener configured to adjust the diameter in response to torque applied to the fastener.

24. The pipe fitting system of claim 23, wherein the fastener is configured to engage slots in the first adjustable band to adjust the diameter.

25. The pipe fitting system of claim 21, wherein the first adjustable band is a hose clamp.

26. The pipe fitting system of claim 21, wherein the first adjustable band is made of a metallic material.

27. The pipe fitting system of claim 21, wherein the lock band strap is generally flat, and wherein the lock band strap is made of plastic.

28. The pipe fitting system of claim 27, wherein the lock band strap is configured to conform to a pipe fitting, wherein the pipe fitting is configured to conjoin the first pipe segment and the second pipe segment to form the connection between the first pipe segment and the second pipe segment, and wherein the pipe fitting is configured to be located between the first adjustable band and the second adjustable band relative to a length of the pipe fitting.

29. The pipe fitting system of claim 28, wherein an end of the first pipe segment includes the pipe fitting, and wherein the pipe fitting is a female pipe fitting including a flared portion configured to engage with the second pipe segment.

30. The pipe fitting system of claim 21, comprising an additional lock band strap having an additional plurality of holes, wherein the additional lock band strap is configured to be secured to the first pipe segment via the first adjustable band and secured to the second pipe segment via the second adjustable band.

31. The pipe fitting system of claim 30, wherein the additional lock band strap includes a ridged portion configured to accommodate a raised section of the first pipe segment or the second pipe segment, wherein the raised section is formed by a pipe fitting configured to facilitate the connection between the first pipe segment and the second pipe segment.

32. The pipe fitting system of claim 21, wherein the lock band strap is configured to be secured to the first pipe segment via the first adjustable band and secured to the second pipe segment via the second adjustable band to maintain the connection between the first pipe segment and the second pipe segment.

33. A pipe fitting retention system, comprising:
a first adjustable band;
a second adjustable band;
a first plastic lock band strap having a first plurality of holes, wherein the first adjustable band is configured to be fed through a first hole of the first plurality of holes, and the second adjustable band is configured to be fed through a second hole of the first plurality of holes; and
a second plastic lock band strap having a second plurality of holes, wherein the first adjustable band is configured to be fed through a third hole of the second plurality of holes and the second adjustable band is configured to be fed through a fourth hole of the second plurality of holes, wherein the first plastic lock band strap and the second plastic lock band strap are configured to maintain a connection between a first pipe segment and a second pipe segment.

34. The pipe fitting retention system of claim 33, wherein the first adjustable band includes a locking assembly, wherein the locking assembly is configured to adjust a circumference of the first adjustable band.

35. The pipe fitting retention system of claim 33, wherein the first plastic lock band strap and the second plastic lock band strap are configured to at least partially absorb a load pulling the first pipe segment and the second pipe segment away from one another.

36. The pipe fitting retention system of claim 33, wherein the first adjustable band is configured to be fed through a fifth hole of the first plurality of holes, and the second adjustable band is configured to be fed through a sixth hole of the first plurality of holes, and wherein the first adjustable band is configured to be fed through a seventh hole of the second plurality of holes, and the second adjustable band is configured to be fed through an eighth hole of the second plurality of holes.

37. A pipe joint securement device, comprising:
a first adjustable band configured to be secured to a first pipe segment;
a second adjustable band configured to be secured to a second pipe segment, wherein the first pipe segment is axially aligned with and coupled to the second pipe segment at a pipe joint, wherein the first adjustable band and the second adjustable band each include a metallic material; and
a plastic lock strap having a plurality of holes, wherein the plastic lock strap is configured to be secured to the first pipe segment via the first adjustable band and secured to the second pipe segment via the second adjustable band, wherein the first adjustable band is fed through a first hole of the plurality of holes from a first side of the plastic lock strap to a second side of the plastic lock strap, and wherein the first adjustable band is fed through a second hole of the plurality of holes from the second side to the first side, and wherein the plastic lock strap is configured to operatively resist a force pulling the first pipe segment and the second pipe segment away from one another.

38. The pipe joint securement device of claim 37, comprising an additional plastic lock strap configured to be secured to the first pipe segment via the first adjustable band and secured to the second pipe segment via the second adjustable band, wherein the plastic lock strap and the additional plastic lock strap are configured to be located diametrically opposed from one another with respect to the first pipe segment.

39. The pipe joint securement device of claim 37, wherein the plastic lock strap has an elongated shape spanning the pipe joint.

40. The pipe joint securement device of claim 37, wherein the first adjustable band and the second adjustable band are configured to be installed around the first pipe segment and around the second pipe segment, respectively, after the first pipe segment is disposed within the second pipe segment at the pipe joint.
